(19) United States
(12) Patent Application Publication
(10) Pub. No.: US 2024/0354633 A1
(43) Pub. Date: Oct. 24, 2024

(54) AUTOMATIC GENERATION OF EXEMPLAR QUANTITY FOR TRAINING MACHINE LEARNING MODELS

(71) Applicant: ORACLE INTERNATIONAL CORPORATION, Redwood Shores, CA (US)

(72) Inventors: Keyang RU, Kirkland, WA (US); Matthew T. GERDES, Oakland, CA (US); Guang Chao WANG, San Diego, CA (US); Kenny C. GROSS, Escondido, CA (US); Ruixian LIU, San Diego, CA (US)

(21) Appl. No.: 18/133,125

(22) Filed: Apr. 11, 2023

(51) Int. Cl. G06N 20/00

(52) U.S. Cl. CPC G06N 20/00

(57) ABSTRACT

Systems, methods, and other embodiments associated with determining a quantity of exemplar vectors to select from available training vectors are described. In one embodiment, a method includes determining an available quantity of training vectors that are available in a set of time series signals. A boost function is automatically selected from a plurality of different boost functions based on the available quantity of the training vectors. A selection quantity of the exemplar vectors to select from the training vectors is generated by applying the selected boost function to the training vectors. A quantity of the exemplar vectors is selected from the training vectors based on the selection quantity. A machine learning model is trained to detect an anomaly in the time series signals based on the exemplar vectors that were selected.

### BACKGROUND

Machine learning (ML) models may be used to detect anomalies in time series readings. The ML models may be trained to estimate what the time series readings are expected to be based on a collection of training vectors. The collection of training vectors may be down-selected (or filtered to fewer than the entire collection of training vectors) to a subset of vectors that are designated as exemplar vectors. The exemplar vectors are then used to train the machine learning models. Such down-selection reduces compute costs for training and operating the ML model, but also reduces the prognostic accuracy of the ML model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of an inferential exemplar selection system associated with exemplar vector selection for multivariate anomaly detection.

FIG. 2 illustrates one embodiment of an inferential exemplar selection method associated with exemplar vector selection for multivariate anomaly detection.

FIG. 3 illustrates one embodiment of an example inferential exemplar selection method 300 showing selection between four boost functions based on available quantity of training vectors.

FIG. 4 illustrates an embodiment of a computing system configured with the example systems and/or methods disclosed.

### DETAILED DESCRIPTION

Systems, methods, and other embodiments are described herein that determine how many exemplar vectors to use for training an ML model in order to balance competing objectives of prognostic accuracy and compute cost. In one embodiment, an inferential exemplar selection system infers the quantity of exemplar vectors to use based on relationships between training data and ML model performance. In one embodiment, inferential exemplar selection system automatically arrives at a quantity of exemplar vectors that achieves a highest level of ML model accuracy attainable without incurring unreasonable compute costs (of processor time or memory footprint) for operating the ML model.

In one embodiment, inferential exemplar selection system automatically chooses how to determine the quantity of exemplar vectors based on the number of training vectors available in a training data set, and then chooses that quantity of exemplar vectors for use in training. For example, the inferential exemplar selection system counts the number of training vectors that are available. Then, the inferential exemplar selection system automatically selects a boost function corresponding to the number of training vectors. The inferential exemplar selection system then executes the selected boost function to determine how many exemplar vectors to choose from the training vectors. The inferential exemplar selection system then collects the determined quantity of exemplar vectors. The inferential exemplar selection system trains the machine learning model with the collected exemplar vectors.

Absent the inferential exemplar selection system described herein, successfully optimizing how many exemplars should be used to balance prognostic accuracy and compute costs is an infeasible problem. In one embodiment, the inferential exemplar selection system improves the training of ML models by automatically determining how many exemplars should be selected from available training vectors. In one embodiment, the inferential exemplar selection system improves the training of ML models by identifying a quantity of exemplars to use that will result in a least loss of accuracy for a greatest reduction in compute cost. In one embodiment, ML models resulting from training with the identified quantity of exemplars maintaining high prognostic accuracy while minimizing the compute resources needed to train and operate the model. This improves ML prognostic anomaly detection by reducing the amount of compute hardware needed to monitor signals for sensor-intensive applications. For example, sensor-dense vehicles such as modern commercial aircraft (which have 70,000+ sensors to monitor), modern spacecraft, or other weight-sensitive vehicles are enabled to perform highly-accurate anomaly detection with smaller on-board computing devices. This improved reduction in compute hardware requirements is due to the inferential exemplar selection system described herein.

### Definitions

As used herein, the term “time series” refers to a data structure in which a series of data points or readings (such as observed or sampled values) are indexed in time order. In one embodiment, the data points of a time series may be indexed with an index such as a point in time described by a time stamp and/or an observation number. For example, a time series is one “column” or sequence of data points over multiple points in time from one of several sensors used to monitor an asset. As used herein, the terms “time series signal” and “time series” are synonymous. Occasionally, for convenience, a time series signal may be referred to simply as a “signal”.

As used herein, the term “vector” refers to a data structure that includes a set of data points or readings (such as observed or sampled values) from multiple time series at one particular point in time, such as a point in time described by a time stamp, observation number, or other index. For example, a “vector” is one row of data point sampled at one point in time from all sensors used to monitor an asset. A vector may also be referred to herein as an “observation”. As used herein, the term “training vector” refers to a vector that is further designated to be available for use in training a machine learning model. For example, a vector may be designated a training vector by occurring within a range of time indexes designated as a training range, or the vectors may be designated individually as training vectors by adding a mark or flag to the data structure of the vector that indicates the training status.

As used herein, the term “time series database” refers to a data structure that includes multiple time series that share an index (such as a series of points in time, time stamps, time steps, or observation numbers) in common. Or, from another perspective, the term “time series database” refers to a data structure that includes vectors or observations across multiple time series at a series of points in time, that is, a time series of vectors. As an example, time series may be considered “columns” of a time series database, and vectors may be considered “rows” of a time series database. A time series database is thus one type of a set of time series readings.

As used herein, the term “residual” refers to a difference between a value (such as a measured, observed, sampled, or resampled value) and an estimate, reference, or prediction of what the value is expected to be. For example, a residual may be a difference between an actual, observed value and a machine learning (ML) prediction or ML estimate of what the value is expected to be by an ML model. In one embodiment, a time series of residuals or “residual time series” refers to a time series made up of residual values between a time series of values and a time series of what the values are expected to be.

As used herein, the terms “exemplar” or “exemplar vector” refers to a vector used to train a multivariate ML model (such as an ML anomaly detection model). An exemplar vector may also be referred to as a “memory vector,” due to inclusion of exemplar vectors in a matrix of vectors to be used for training the ML model that is referred to as a memory matrix.

### —Example Inferential Exemplar Selection System—

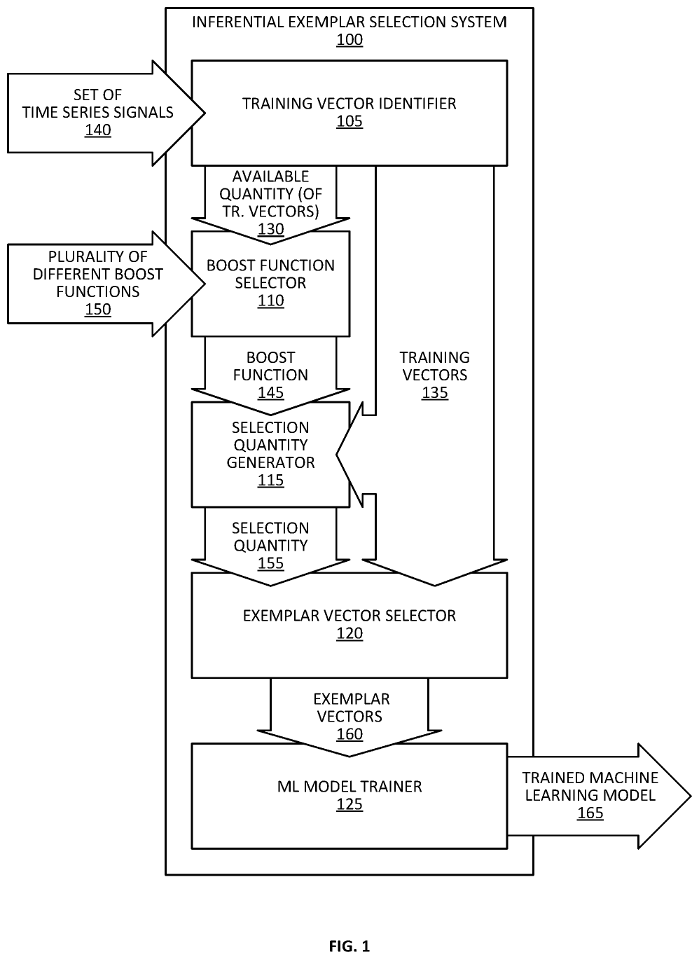

FIG. 1 illustrates one embodiment of an inferential exemplar selection system 100 associated with exemplar vector selection for multivariate anomaly detection. Inferential exemplar selection system 100 includes components for determining a quantity of exemplar vectors to select for training an ML model from a set of training vectors. In one embodiment, the determined quantity is an optimum quantity of exemplar vectors that balances accuracy of an ML model trained with the quantity of exemplar vectors against compute resource requirements for the training using the quantity of exemplar vectors. In one embodiment, inferential exemplar selection system 100 causes the ML model to be trained to a level of accuracy without exceeding resource constraints during the training.

In one embodiment, components of inferential exemplar selection system 100 include training vector identifier 105, boost function selector 110, selection quantity generator 115, exemplar vector selector 120, and ML model trainer 125. In one embodiment, training vector identifier 105 is configured to determine an available quantity 130 of training vectors 135 that are available in a set of time series signals 140. The training vectors 135 are for use in training a machine learning model.

In one embodiment, boost function selector 110 is configured to automatically select a boost function 145 from a plurality of different boost functions 150. The selected boost function 145 is selected by boost function selector 110 based on the available quantity 130 of the training vectors 135 falling within a quantity range. For example, boost function selector 110 is configured to, in response to the available quantity 130 of the training vectors 140 being within a first quantity range, select a first boost function from the plurality of different boost functions 150. And, boost function selector 110 is configured to, in response to the available quantity 130 of the training vectors 135 being within a second quantity range, selecting a second boost function from the plurality of different boost functions 150. Each boost function from the plurality of different boost functions 150 generates a different selection quantity of exemplar vectors to be selected from the training vectors 140.

In one embodiment, selection quantity generator 115 is configured to generate a selection quantity 155 of exemplar vectors 160 to select from the training vectors 135. Selection quantity generator 115 is configured to generate the selection quantity 155 of exemplar vectors, for example by applying the selected boost function 145 to the training vectors 135. In one embodiment, exemplar vector selector 120 is configured to select a quantity of the exemplar vectors 160 from the training vectors based on the selection quantity 155.

In one embodiment, ML model trainer 125 is configured to train the machine learning model 165 to detect an anomaly in the time series signals 140 based on the exemplar vectors 160 that were selected. The machine learning model 165 is trained based on the exemplar vectors 160 in order to achieve a level of accuracy for the trained machine learning model 165 without exceeding resource constraints during the training.

In one embodiment, each of these components 105, 110, 115, 120, and 125 of inferential exemplar selection system 100 may be implemented as software executed by computer hardware. For example, components 105, 110, 115, 120, and 125 may be implemented as one or more intercommunicating software modules, routines, or services for performing the functions of the components described herein.

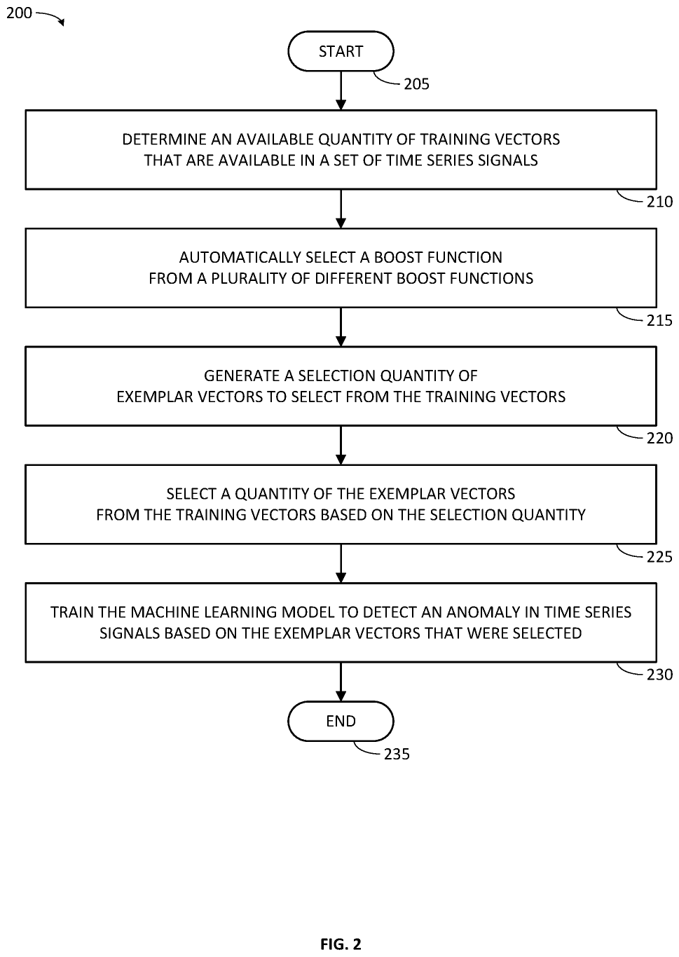

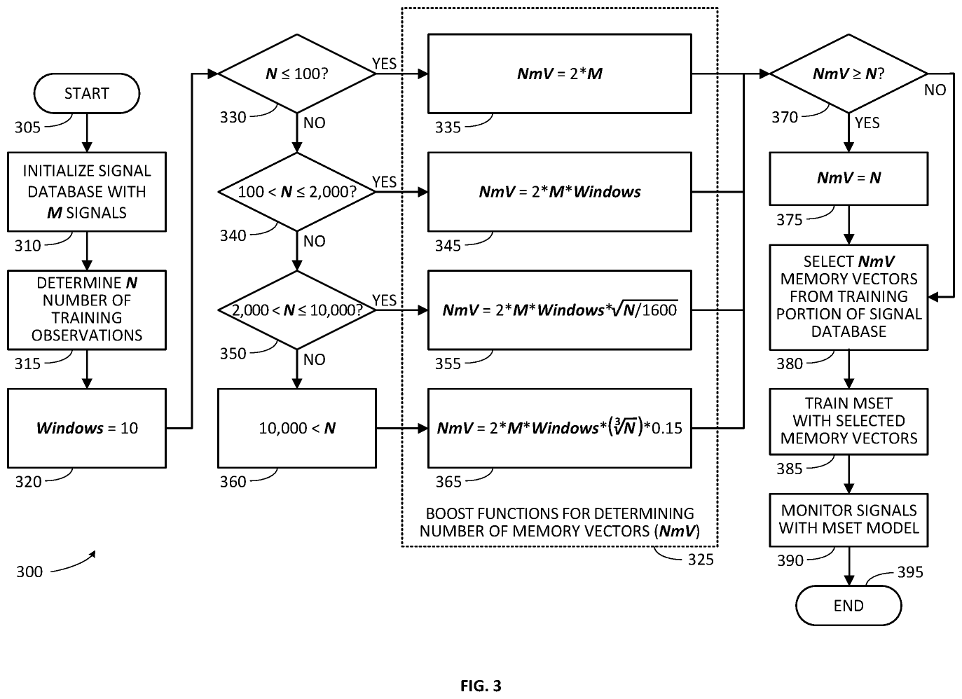

Further details regarding inferential exemplar selection system 100 are presented herein. In one embodiment, the operation of inferential exemplar selection system 100 will be described with reference to example inferential exemplar selection methods 200 and 300 shown in FIGS. 2 and 3, respectively.

### —Example Inferential Exemplar Selection Method—

FIG. 2 illustrates one embodiment of an inferential exemplar selection method 200 associated with exemplar vector selection for multivariate anomaly detection. As an overview, in one embodiment, inferential exemplar selection method 200 determines a quantity of exemplar vectors to be selected from a collection of training vectors, and then selects exemplar vectors to fill the quantity and trains an ML model based on the selected exemplars. The quantity of exemplar vectors is determined by a boost function that is automatically selected from among several alternative boost functions. The boost function is automatically selected based on the amount of training vectors that are available. For example, several ranges are established for the quantity of available training vectors, so that each range is uniquely associated with one of the boost functions. Where the number of training vectors that are available fall within a given range, the boost function associated with the given range is used to determine the quantity of exemplar vectors to be selected. In one embodiment, the quantity of exemplar vectors produced by the boost function for the given range results in a quantity of exemplar vectors that result in a greatest level of ML model accuracy available before compute and memory costs of ML model training become exorbitant.

In one embodiment, inferential exemplar selection method 200 initiates at START block 205 in response to an inferential exemplar selection system (such as system 100) determining one or more of (i) that an inferential exemplar selection system has received a set of time series signals; (ii) that an instruction to perform inferential exemplar selection method 200 on a set of time series signals has been received (iii) a user or administrator of an inferential exemplar selection system has initiated inferential exemplar selection method 200; (iv) it is currently a time at which inferential exemplar selection method 200 is scheduled to be run; or (v) that inferential exemplar selection method 200 should commence in response to occurrence of some other condition. In one embodiment, a computer system configured by computer-executable instructions to execute functions of inferential exemplar selection system 100 executes inferential exemplar selection method 200. Following initiation at start block 205, inferential exemplar selection method 200 continues to process block 210.

### —Example Method—Determining Available Quantity of Training Vectors—

At process block 210, inferential exemplar selection method 200 determines an available quantity of training vectors that are available in a set of time series signals. The training vectors are designated for use in training a machine learning model. Put another way, inferential exemplar selection method determines an available quantity of training vectors designated for use in training a machine learning model. For example, inferential exemplar selection method 200 obtains a count of vectors designated for training. The number of the vectors that make up a training sub-set in the set of time series signals is identified.

In one embodiment, inferential exemplar selection method 200 accesses a set of time series signals. The set of time series signals may include multiple signals (also referred to as a plurality of signals). The set of time series signals may be a time series database or other collection of time series signals. The set of time series signals includes vectors at shared index positions in the time series signals. The vectors are thus observations across the set of time series signals at one time index. Each of the plurality of signals represents behavior over time for a variable, such as a sensed value from a sensor. In one embodiment, the time series readings are collected from a plurality of sensors by recording or sampling values that are output by the plurality of sensors at an interval of time. In one embodiment, readying the set of time series signals for use by inferential exemplar selection method 200 may be referred to as initializing the signal database. In one embodiment, the inferential exemplar selection method 200 accesses the set of time series signals by retrieving or otherwise obtaining them from storage.

In one embodiment, inferential exemplar selection method 200 discovers or identifies a training range of the set of time series signals. The set of time series signals covers a range of indexes (such as, a range of time points). In one embodiment, the set of time series signals is a series of vectors at individual index points (such as points in time). A range of vectors may be designated as a training range of the time series signals. Another range of the index may be designated as a surveillance range of the time series signals. For example, a user may specify the training range, for example by selecting a beginning index position and an end index position for the training range. The specified training range is considered by the user to represent typical, expected, normal, correct, or otherwise unexceptional signal values in the set of time series signals. In one embodiment, the user may designate a range beginning with the earliest vector to be the training range, for example, a range covering the first 50% of the vectors. In one embodiment, the training range and surveillance range are continuous ranges that are discrete from each other. In one embodiment, vectors may be designated individually as training vectors or surveillance vectors. For example, the designation may be made by setting a flag or other data structure of the vector, or associated with the vector, that indicates the status of the vector as a training vector or surveillance vector.

The vectors that are included within the training range are available for use in training an ML model to predict typical signal values. The vectors within the training range may be referred to herein as “training vectors” or “training observations”. The vectors outside of the training range (such as the vectors that are in the surveillance range) are not available for use in training the ML model. For example, the training data (or available training vectors) thus define the training range. Thus, in one embodiment, a training vector is one that has been designated as acceptable for use in training, although not all of the training vectors are necessarily used for training. Training vectors are made available, that is, set aside or reserved, for training of an ML model. During training of the ML model, the training vectors may be used to provide reference values for each variable or signal that the correlation patterns of the ML model are being adjusted to fit. The ML model will be trained using a subset of the training vectors selected from the training vectors that are referred to as exemplar vectors. In one embodiment, the ML model is a multivariate prognostic anomaly detection model (for example as discussed below under the heading “Overview of Multivariate ML Anomaly Detection”). The trained ML model is used to detect anomalous departures from typical signal behavior by comparison of model-predicted and actual values for the signals.

In one embodiment, inferential exemplar selection method 200 determines an available quantity of the training vectors. Determining the available quantity of training vectors provides a count or tally of how many training vectors there are in the training range. For example, the training vectors make up or constitute the training range. In one embodiment, inferential exemplar selection method 200 discovers the training range. For example, inferential exemplar selection method 200 identifies the beginning and ending index positions of the training range, such as by retrieving them from storage. Then inferential exemplar selection method 200 derives the available quantity based on the training range. For example, inferential exemplar selection method 200 counts the quantity of signals that are available from (that is, included in) the training range between the beginning and ending index positions. Or, for example, where the index values are observation numbers rather than time stamps, subtracting beginning and ending observation numbers for the training range generates the available quantity. The available quantity is the count of vectors or observations that are included in training data (and thus designated to be available for use for training).

Thus, in one embodiment, inferential exemplar selection method 200 determines an available quantity of training vectors that are available in a set of time series signals by accessing a set of time series signals; getting a designation of a training range within the set of time series signals; counting, calculating, or otherwise deriving a tally of the quantity of vectors included in the training range; and storing the tally as the available quantity of the training vectors. Process block 210 then completes, and inferential exemplar selection method 200 continues at process block 215. In one embodiment, the functions of process block 210 are performed by training vector identifier 105 of inferential exemplar selection system 100. At the conclusion of determines an available quantity of training vectors that are available in a set of time series signals in process block 210, the available quantity of training vectors is known. The available quantity is a basis for determining how many exemplar vectors are to be selected. More particularly, the available quantity is a basis for selecting a boost function that infers how many exemplars are to be selected from the training vectors.

### —Example Method—Automatically Selecting a Boost Function—

At process block 215, inferential exemplar selection method 200 automatically selects a boost function from a plurality of different boost functions. The selected boost function is selected based on the available quantity of the training vectors falling within a quantity range. The quantity range is associated with the selected boost function. For example, in response to the available quantity of the training vectors being within a first quantity range, inferential exemplar selection method 200 selects a first boost function from a plurality of different boost functions, and in response to the available quantity of the training vectors being within a second quantity range, inferential exemplar selection method 200 selects a second boost function from the plurality of different boost functions. Each boost function from the plurality of different boost functions is configured to generate or determine a different selection quantity of exemplar vectors to be selected from the training vectors.

In one embodiment, a boost function produces a target quantity or count for the number of exemplar vectors that are to be selected from the training vectors. The quantity of exemplar vectors generated by the boost function may be referred to as a selection quantity of the exemplar vectors. The boost function generates the selection quantity of exemplar vectors. For example, the boost function is a function for increasing the selection quantity of exemplar vectors as the available quantity of training vectors increases. The boost function is so called because it is a function for increasing—that is, boosting—the number of exemplar vectors to be selected as the count of training vectors goes up. A naïve boosting function, such as selecting a fixed percentage of the training vectors to be exemplar vectors would quickly become wasteful due to a cubic relationship between number of training vectors and compute cost to train an ML model and asymptotic relationship between number of training vectors and accuracy.

In one embodiment, inferential exemplar selection method 200 selects a boost function from among a plurality of boost functions. The plurality of boost functions provides a progressively lower portion of the training vectors to be exemplar vectors as the available quantity of training vectors increases. In one embodiment, the boost functions are segments of a piecewise function, in which individual boost functions are applicable within specific quantity ranges of training vectors. In one embodiment, the boost functions are different and expand the selection quantity of exemplar vectors in unlike or dissimilar ways based on how many training vectors there are. For example, each boost function from the plurality of different boost functions generates a different selection quantity of exemplar vectors to be selected from the training vectors.

In one embodiment, the selection of a boost function is responsive to the available quantity satisfying conditions associated with the use of the boost function. Inferential exemplar selection method 200 chooses among the boost functions automatically or autonomously based on the count of training vectors being within one of a plurality of quantity ranges. The quantity ranges are defined by lower and upper boundaries of threshold vector amounts, and the available quantity is within a given quantity range when the available quantity is between the lower-boundary and upper boundary (endpoints) for the range. In one embodiment, each quantity range is associated with or corresponds to a boost function. For example, the correspondence is a one-to-one relationship between a quantity range and a boost function.

In one embodiment, inferential exemplar selection method 200 automatically decides between two (or more) boost functions by determining whether the available quantity is in one quantity range or another. Thus, when the available quantity of training vectors is within one quantity range, inferential exemplar selection method 200 chooses one boost function that corresponds to the one quantity range; and when the available quantity of training vectors is within another quantity range, inferential exemplar selection method 200 chooses another boost function that corresponds to the other quantity range. Thus, inferential exemplar selection method 200 automatically picks the function for generating the target quantity of exemplar vectors in response to satisfaction of quantity range thresholds by the available quantity. The available quantity of the training vectors thus dictates the boost function chosen.

In one embodiment, inferential exemplar selection method 200 automatically selects from among four different boost functions based on the available quantity of training vectors (training observations) falling within one of four quantity ranges, as discussed in additional detail below, for example at blocks 325-365 of FIG. 3 below. In a first quantity range where the available quantity of training vectors is small, for example falling within the range between 0 and approximately 100, inferential exemplar selection method 200 automatically selects a first boost function that corresponds to the first range. In a second quantity range where the available quantity of training vectors is moderate, for example falling within the range between approximately 100 and approximately 2,000, inferential exemplar selection method 200 automatically selects a second boost function that corresponds to the second range. In a third quantity range where the available quantity of training vectors is large, for example falling within the range between approximately 2,000 and approximately 10,000, inferential exemplar selection method 200 automatically selects a third boost function that corresponds to the third range. In a fourth quantity range where the available quantity of training vectors is very large, for example falling within the range above approximately 10,000, inferential exemplar selection method 200 automatically selects a fourth boost function that corresponds to the fourth range. Note that the quantity ranges specified herein are examples, and that the boundaries of the quantity ranges may vary based on compute capabilities of underlying hardware hosting the system. Further details of the boost functions are discussed below, for example in process block 220, and process blocks 325-365.

Thus, in one embodiment, inferential exemplar selection method 200 automatically selects a boost function from a plurality of different boost functions by accessing the available quantity of training vectors; comparing the available quantity to thresholds that define quantity ranges; finding one quantity range for which the available quantity satisfies the thresholds; selecting a boost function associated with the quantity range, and storing the selection of boost function for subsequent processing. Process block 215 then completes, and inferential exemplar selection method 200 continues at process block 220. In one embodiment, the functions of process block 215 are performed by boost function selector 110 of inferential exemplar selection system 100. At the completion of process block 215, one of a plurality of boost functions has been selected that corresponds to the amount of training vectors that are available. The selected boost function will degenerate an appropriate selection quantity of the vectors.

### —Example Method—Generating a Selection Quantity of the Exemplar Vectors—

At process block 220, inferential exemplar selection method 200 generates a selection quantity of exemplar vectors to select from the training vectors by applying the selected boost function to the training vectors. In one embodiment, the processor executes the selected boost function to produce the selection quantity for the exemplar vectors.

In one embodiment, exemplar vectors are a subset of the training vectors. The exemplar vectors are vectors that are considered to be representative of the training vectors. The exemplar vectors are used to train the ML model effectively without using the entire set of training vectors. In one embodiment, a selection quantity of exemplars is an amount of vectors that will be enough to train the ML model. The selection quantity is a goal or target amount of the exemplar vectors to be selected. In other words, the selection quantity is an amount of exemplar vectors to be chosen from the training vectors.

In one embodiment, the selected boost function determines how many vectors (the selection quantity) to pick from the training vectors to be exemplars. In one embodiment, inferential exemplar selection method 200 performs or executes the selected boost function to generate the selection quantity. In one embodiment, the selection quantity is produced by applying the selected boost function to the training vectors. To apply the selected boost function to the training vectors, in one embodiment, inferential exemplar selection method 200 picks out information that is relevant to the boost function from the training vectors (or from the set of time series signals). The information gathered from the training vectors are values for variables of the selected boost function. Once the values of the variables are collected, the selected boost function is executed using those values. The selected boost function thus produces the selection quantity based on information about the training data.

For example, a first boost function is a multiple of a constant and the number of signals in the set of signals. The number of signals may be obtained from the training data, for example by counting the number of signals, or from a training vector, for example by counting the number of variables in the vector. Once the number of signals is thus obtained, the first boost function is executed to multiply the number of signals by the constant. In one embodiment, the constant is 2 or higher. Additional detail regarding the first boost function is described below, for example with reference to block 335 of FIG. 3.

In another example, a second boost function is a multiple of a constant, the number of signals, and a number of windows or divisions of the training range. The number of windows may be pre-specified by a user. In one embodiment, the number of signals and the constant are as described above for the first boost function. The second boost function is executed to multiply the number of signals by the constant and by the number of windows. In one embodiment, the number of windows is 10. Additional detail regarding the second boost function is described below, for example under the heading “Additional Embodiments” and also with reference to block 345 of FIG. 3.

In another example, a third boost function is a multiple of a constant, the number of signals, a number of windows, and a square root taper coefficient. The square root taper coefficient scales back the selection quantity. In one embodiment, the number of signals, the constant, and the number of windows are as described above for the first and second boost functions. The selection quantity is tapered in a manner that ameliorates a square relationship between the quantity of exemplars used for training an ML model and the memory footprint of the ML model. In one embodiment, the square root taper coefficient is proportional to the available quantity of training vectors. In one embodiment, the square root taper coefficient is the square root of the quotient of the available quantity divided by another constant, such as 1600. Additional detail regarding the third boost function is described below, for example under the heading “Additional Embodiments” and also with reference to block 355 of FIG. 3.

In another example, a fourth boost function is a multiple of a constant, the number of signals, a number of windows, and a cube root taper coefficient. The cube root taper coefficient also scales back the selection quantity. In one embodiment, the number of signals, the constant, and the number of windows are as described above for the first and second boost functions. The selection quantity is tapered in a manner that ameliorates a cubic relationship between the quantity of exemplars used for training an ML model and the processor time for training or executing the ML model. In one embodiment, the cube root taper coefficient is proportional to the available quantity of training vectors. In one embodiment, the cube root taper coefficient is the product of the cube root of the available quantity and a further constant, such as 0.15. Additional detail regarding the fourth boost function is described below, for example under the heading “Additional Embodiments” and also with reference to block 365 of FIG. 3.

In one embodiment, the values of the variables for the various boost function above may be identified from the training vectors to apply the selected boost function to the training vectors. Thus, the boost function is applied to the training data by picking out the number of signals, the available quantity of training vectors, the number of windows, or other relevant characteristics of the training vectors that are included as variables in the boost function. Once the variables of the selected boost function are populated, inferential exemplar selection method 200 executes the selected boost function using the variables to generate the selection quantity.

Thus, in one embodiment, inferential exemplar selection method 200 generates a selection quantity of exemplar vectors to select from the training vectors by gathering the values for the variables of the selected boost function; executing the boost function using the gathered values to produce the selection quantity; and recording the resulting selection quantity for subsequent processing. Process block 220 then completes, and inferential exemplar selection method 200 continues at process block 225. In one embodiment, the functions of process block 220 are performed by selection quantity generator 115 of inferential exemplar selection system 100. In one embodiment, at the conclusion of process block 220, inferential exemplar selection method 200 has determined how many of the training vectors should be chosen to be exemplar vectors: the selection quantity. In one embodiment, the selection quantity is a number of exemplar vectors that is sufficient to train the ML model to an acceptable level of accuracy without becoming wasteful in consumption of compute resources. The selection quantity may be used as a basis for an amount of exemplar vectors to be selected.

### —Example Method—Selecting Exemplar Vectors—

At process block 225, inferential exemplar selection method 200 selects a quantity of the exemplar vectors from the training vectors based on the selection quantity. For example, inferential exemplar selection method 200 may select the selection quantity of training vectors to be exemplar vectors. Or, for example, inferential exemplar selection method 200 may choose approximately the selection quantity of training vectors to be exemplar vectors.

In one embodiment, inferential exemplar selection method 200 implements a selection algorithm to obtain exemplar vectors from the training vectors. In one embodiment, training vectors may be selected to be exemplar vectors no more than once in the selection process. When a training vector is chosen to become an exemplar vector, the training vector may be removed from the set of training vectors or marked unavailable for further selection. And, when a training vector is picked to become an exemplar, the training vector may be added to a set of exemplar vectors. In one embodiment, the selection algorithm selects exemplar vectors until the set of exemplar vectors includes the selection quantity of vectors. In one embodiment, the set of exemplar vectors is stored in a memory matrix or other data structure that may be used for training an ML model. Thus, in one embodiment, inferential exemplar selection method 200 filters the training vectors to remove training vectors that do not satisfy conditions of the selection algorithm, leaving only the exemplars. And, inferential exemplar selection method 200 filters the training vectors to retain the exemplar vectors that satisfy conditions of the selection algorithm.

In one embodiment, the selection algorithm selects exemplars by random sampling. In one embodiment, other selection algorithms may be employed. In one embodiment, the selection algorithm is performed to select a portion of the exemplars (such as the selection quantity divided by the number of windows) from multiple windows. In one embodiment, the selection algorithm operates to select an exemplar as many times as indicated by the selection quantity. In this way, the memory matrix is filed with the selection quantity of exemplar vectors.

Thus, in one embodiment, inferential exemplar selection method 200 selects a quantity of the exemplar vectors from the training vectors based on the selection quantity by executing a selection algorithm to select a training vector to be an exemplar vector and storing the exemplar vector in the memory matrix. The selection and storage cycle may be performed repeatedly for the selection quantity of times, to collect the selection quantity of exemplar vectors from the set of training vectors. Process block 225 then completes, and inferential exemplar selection method 200 continues at process block 230. In one embodiment, the functions of process block 225 are performed by exemplar vector selector 120 of inferential exemplar selection system 100. At the conclusion of process block 225, a set of exemplar vectors have been selected for training an ML model, and set aside or stored (for example in a memory matrix). In one embodiment, because the set of exemplar vectors include the selection quantity of vectors, the set of exemplar vectors is large enough to result in at least a level of prognostic accuracy for the machine learning model that does not require excessive computing resources.

### —Example Method—Training the Machine Learning Model—

At process block 230, inferential exemplar selection method 200 trains the machine learning model to detect anomalies in the time series signals based on the exemplar vectors that were selected. In one embodiment, training the ML model using the selected exemplar vectors achieves a level of accuracy for the trained machine learning model without exceeding resource constraints.

In one embodiment, to train the machine learning model, the machine learning model is provided with the exemplar vectors as multivariate inputs to the machine learning model during a training session. One by one, the machine learning model extracts the values provided for the variables (signals) in the exemplar vectors, and adjusts a configuration of the machine learning model to cause the machine learning model to produce estimates consistent with the values provided by the exemplars. The training causes the machine learning model to produce estimates of what each variable is expected to be based on the actual values of other signals. Differences or residuals between the estimates may be provided to a detection model such as a sequential probability ratio test (SPRT) to detect when deviations form expected signal values are anomalous. Additional detail on training of the machine learning model to detect an anomaly is provided below under the heading “Overview of Multivariate ML Anomaly Detection”.

As mentioned above, the training is based on those exemplar vectors that were selected in order to achieve the level of accuracy for the ML model without exceeding resource constraints. This balance between ML model accuracy and resources consumed by ML model training is achieved by using exemplar vectors selected as described, for example, at process blocks 210-225 above. In one embodiment, the machine learning model that has been trained with the selected exemplar vectors will complete the training session without exceeding the resource constraints. And, in one embodiment, the machine learning model that has been trained with the selected exemplar vectors will operate to monitor the set of time series signals in a surveillance phase without exceeding the resource constraints. In one embodiment, the machine learning model trained with the selected exemplar vectors maintains a level of prognostic accuracy despite using fewer than all of the available training vectors. For example, the level of prognostic accuracy for the ML model—which may be measured by FAPs and MAPs for the ML model—detects anomalies with essentially no reduction in accuracy, when the training vectors are down-selected to the selection quantity identified by inferential exemplar selection method 200.

Process block 230 then completes, and inferential exemplar selection method 200 continues to END block 235, where inferential exemplar selection method 200 concludes. In one embodiment, the functions of process block 230 are performed by ML model trainer 125 of inferential exemplar selection system 100. At the conclusion of process block 230, a machine learning model has been trained to detect anomalies based on an automatically-selected quantity of exemplar vectors. In one embodiment, the automatic selection down-selects a set of training vectors into a set of exemplar vectors. The set of training vectors may be too large to use for training of ML models within compute resource constraints. In one embodiment, the set of exemplar vectors includes an automatically identified minimal quantity of exemplars that will train the ML model to a level of prognostic accuracy without overburdening compute resources. Thus, in one embodiment, inferential exemplar selection method 200 allows training and operation of ML models within the compute resource constraints while losing little to no accuracy when compared with ML models trained with larger subsets of the training vectors. In one embodiment, the trained ML models are thus highly accurate while also efficient in use of compute resources such as processing time and memory.

### —Further Embodiments of Inferential Exemplar Selection Method—

In one embodiment, different boost functions produce different selection quantities. In one embodiment, the selected boost function adjusts the selection quantity of the exemplar vectors by a different coefficient for each of a set of quantity ranges. The set of quantity ranges includes the quantity range discussed in process block 215 above.

In one embodiment, the boost function limits the growth of the selection quantity due to number of signals by applying a taper coefficient. In one embodiment, inferential exemplar selection method 200 applies a taper coefficient in the boost function. The taper coefficient reduces the selection quantity by an extent that is based on the available quantity of the training vectors. In one embodiment, different taper coefficients are applied in different boost functions. For example, generating the selection quantity of exemplar vectors as described above with reference to process block 220 includes, in response to selection of a first boost function, adjusting the selection quantity of the exemplar vectors by a first coefficient, and in response to selection of the second boost function, adjusting the selection quantity of the exemplar vectors by a second coefficient.

In one embodiment, different taper coefficients are applied when the number of available training vectors causes different computing costs to dominate the training process. Therefore, in one embodiment, in response to the quantity range satisfying a threshold for being a memory-specific range, inferential exemplar selection method 200 applies a square root taper coefficient in the boost function. The available quantity of training vectors falling within the memory-specific range indicates that memory is a dominant constraint of the resource constraints during training and/or surveillance operations. In other words, in the memory-specific range, memory footprint drives resource consumption during training. In one embodiment, the quantity range satisfies a threshold for being a memory-specific range where runtime memory consumed due to number of signals drives expansion of compute resource requirements, rather than processor time. Thus, in one embodiment, the threshold to enter the memory-specific range is set at an available number of training vectors that causes processing time to contribute significantly to resource consumption. This point may be pre-determined and set by a user based on the capabilities of underlying hardware. The square root taper coefficient is a square root function of the available quantity of the training vectors. The square root taper coefficient attenuates the selection quantity by a square root function of the available quantity of the training vectors to lessen, reduce, diminish, or otherwise taper off the selection quantity produced.

And, in one embodiment, in response to the quantity range satisfying a threshold for being a processor-specific range, inferential exemplar selection method 200 applies a cube root taper coefficient in the boost function. The available quantity of training vectors falling within the processor-specific range indicates that processor time is a dominant constraint of the resource constraints during training and/or surveillance operations. In other words, in the processor-specific range, processing cost or processor time drives resource consumption during training. In one embodiment, the quantity range satisfies a threshold for being a processor-specific range where processor time consumed due to available quantity of training vectors drives expansion of compute resource requirements, rather than memory footprint. Thus, in one embodiment, the threshold to enter the processor-specific range (and leave the memory-specific range) occurs at an available quantity that first calls for compute resources beyond those required to accommodate the memory footprint for the number of signals. This threshold may be approximate. This threshold may vary based on the capabilities of underlying hardware. The cube root taper coefficient is a cube root function of the available quantity of the training vectors. The cube root taper coefficient attenuates the selection quantity by a cube root function of the available quantity of the training vectors to lessen, reduce, diminish, or otherwise taper off the selection quantity produced.

Thus, in one embodiment, generating the selection quantity of exemplar vectors as discussed in process block 220 above includes, (i) in response to selection of a first boost function, lessening the selection quantity of the exemplar vectors by a square root taper coefficient that attenuates the selection quantity by a square root function, and (ii) in response to selection of the second boost function, lessening the selection quantity of the exemplar vectors by a cube root taper coefficient that attenuates the selection quantity by a cube root function. Or, more generally, inferential exemplar selection method 200 proceeds to, (i) in response to selection of a first boost function, adjust the selection quantity of the exemplar vectors by a first coefficient, and (ii) in response to selection of a second boost function, adjust the selection quantity of the exemplar vectors by a second coefficient.

As discussed in additional detail with reference to example inferential exemplar selection method 300 below, in one embodiment, there are four different boost functions which are applicable to four quantity ranges of available training vectors. In one embodiment, the four quantity ranges separate quantities of training vectors that present different demands on computing resources during training. The four different boost functions corresponding to the quantity ranges address the differing demands presented by different sizes of the training dataset. One of the four boost functions is selected based on the demand the available quantity places on computing resources during training. Thus, in one embodiment, automatically selecting a boost function as discussed above at process block 215 includes selecting one of the four boost functions based on the quantity range that the available quantity of training vectors falls within.

In one embodiment, in response to the available quantity falling within a quantity range for which neither memory nor processor time are significant constraints of the resource constraints, inferential exemplar selection method 200 selects a first boost function that is a linear function of a signal quantity of the time series signals. In one embodiment, where the quantity range is less than a first threshold, inferential exemplar selection method 200 selects a first boost function that is a linear function of a signal quantity of the time series signals. For example, the first threshold is an available quantity of training vectors between 10 and 1000, such as an available quantity of approximately 100.

In one embodiment, in response to the available quantity falling within a quantity range for which the available quantity is sufficiently large to allow short term activity to be missed (and thus result in poor ML model accuracy due to an inequitable selection of exemplars), inferential exemplar selection method 200 selects a second boost function that is a function of a window quantity of windows that subdivide the training vectors and the signal quantity of the time series signals. In one embodiment, where the quantity range is between the first threshold and a second threshold that is higher than the first threshold, inferential exemplar selection method 200 selects a second boost function that is a function of a window quantity of windows that subdivide the training vectors and the signal quantity of the time series signals. Additional detail regarding windows is discussed elsewhere herein, for example with reference to process block 320 and 345 of FIG. 3. In one example, the second threshold is an available quantity of training vectors between 200 and 20,000, such as an available quantity of approximately 2,000. In one embodiment, the second threshold is the threshold for entering the memory-specific range (as the available quantity increases).

In one embodiment, in response to the available quantity falling within a quantity range for which memory is a dominant constraint of the resource constraints (also referred to herein as a memory-specific range), inferential exemplar selection method 200 selects a third boost function that is tapered by a square root function of the available quantity of the training vectors. In one embodiment, where the quantity range is between the second threshold and a third threshold that is higher than the second threshold, inferential exemplar selection method 200 selects a third boost function that is tapered by a square root function of the available quantity of the training vectors. For example, the third threshold is an available quantity of training vectors between 1,000 and 100,000, such as an available quantity of approximately 10,000. In one embodiment, the third threshold is the threshold for leaving the memory-specific range and entering the processor-specific range (as the available quantity increases).

In one embodiment, in response to the available quantity falling within a quantity range for which processor time is a dominant constraint of the resource constraints (also referred to herein as a processor-specific range), inferential exemplar selection method 200 selects a fourth boost function that is tapered by a cube root function of the available quantity of the training vectors. In one embodiment, where the quantity range is more than the third threshold, inferential exemplar selection method 200 selects a fourth boost function that is tapered by a cube root function of the available quantity of the training vectors.

In one embodiment, the training vectors are partitioned into windows to be sampled. Sampling from more than one window ensures exemplars are drawn from a fuller time range of the training vectors. In one embodiment, inferential exemplar selection method 200 also subdivides the training vectors into a predetermined number of windows. The quantity of the exemplar vectors are selected from the training vectors within more than one of the windows. In one embodiment, inferential exemplar selection method 200 subdivides the training vectors into a plurality of windows. Then, inferential exemplar selection method 200 increases the selection quantity of the exemplar vectors to accommodate selections of the training vectors from within the plurality of windows. Additional detail regarding windows is discussed elsewhere herein, for example with reference to process block 320 and 345 of FIG. 3.

In one embodiment, the selection quantity of vectors to be selected from the training vectors is prevented from exceeding the available quantity of the training vectors, as discussed below with reference to blocks 370-375 of FIG. 3. In one embodiment, prior to selecting the exemplar vectors from the training vectors, inferential exemplar selection method 200 constrains the selection quantity of the exemplar vectors to not exceed the available quantity of the training vectors. For example, inferential exemplar selection method 200 reduces the selection quantity of the exemplar vectors to the available quantity of the training vectors in response to the selection quantity exceeding the available quantity.

In one embodiment, inferential exemplar selection method 200 detects an anomaly in the time series signals using the trained machine learning model. In one embodiment, inferential exemplar selection method 200 monitors the time series signals with the trained machine learning model to detect an anomaly. And, in response to detecting a particular anomaly in the time series signals, inferential exemplar selection method 200 generates an electronic alert that the particular anomaly has occurred. Additional detail on monitoring time series signals for anomalies is provided below under the heading “Overview of Multivariate ML Anomaly Detection”, and additional detail regarding the generation of an electronic alert is described herein under the heading “Electronic Alerts”.

### —Additional Embodiments—

In one embodiment, a technique for inferential exemplar vector (memory vector) selection is presented herein. The inferential exemplar selection technique autonomously selects a “just right” or “optimal” number of exemplar vectors to balance the following competing objectives: first, getting the highest reasonably achievable prognostic accuracy from ML predictive/prescriptive prognostic monitoring algorithm; and second, utilizing the lowest reasonably achievable compute cost (processor time and memory) when the ML algorithm is being trained or run.

As sensor deployments become increasingly dense, and as sensor sampling rates climb, it has been observed that the size of time series databases has been growing not linearly, but geometrically. The high diversity of very large sizes for time series data has rendered it impracticable to determine how many exemplar vectors should be used to train ML models for the data. In particular, it is not feasible to determine how much a training dataset can be down-sampled to reduce demands on compute resources while maintaining sufficient accuracy in the ML model. A number of exemplar vectors that was satisfactory for a few dozen sensors at low sampling rates is not sufficient to produce accurate ML models for data with order(s) of magnitude more sensors and/or orders of magnitude higher sampling rates. Nor can a number of exemplar vectors that correctly balances prognostic accuracy and compute resource consumption be readily guessed.

In one embodiment, the inferential exemplar selection techniques, systems, and methods described herein autonomously selects an optimum number of exemplar vectors for training the ML model that balances the tradeoff between prognostic accuracy of the ML model and compute cost for the system hosting the ML model. As prognostic ML use cases have grown from conventional megabytes and gigabytes, into the newer realms of petabytes and terabytes, this tradeoff between prognostic accuracy and compute cost has become severe. Because compute cost for ML prognostics scales exponentially with the square of the number of sensors (or signals) and geometrically with the cubic power of the number of observations (that is, sampling rates). Further, there is a cubic relationship between the quantity of exemplar vectors used for training and increase in computational complexity. In other words, the rate of computational increase caused by increasing the selection quantity of exemplar vectors is cubic.

In one embodiment, the inferential exemplar selection techniques, systems, and methods described herein provide optimal autonomous inferential vector selection criteria that are responsive to these nonlinear relationships, as follows:
1) In a first range where the numbers of training observations (training vectors) is small, the inferential exemplar selection technique provides an abundance of exemplar vectors in cases where there are few training vectors, because in such cases memory footprints and compute cost to train or operated the ML model are insignificant. One example of this first range and corresponding boost function for providing many exemplar vectors is shown and described below with reference to blocks 330 and 335 of FIG. 3.
2) In a second range where the numbers of training observations (training vectors) are moderate or of “medium size”, the available quantity of training observations is large enough to allow short term activity to be missed, and thereby result in an inequitable distribution of exemplar vectors that cause poor ML model performance. In the second range, the inferential exemplar selection technique initially boosts the number of exemplar vectors rather aggressively to ensure that both bias and variance (and standard deviation) of residuals produced by the ML model stay well-behaved, and still with minimal impact on memory consumption and compute cost. Bias (mean) of the residuals is well-behaved when it is closer to zero, that is, where the mean of the residuals is near or at zero. Variance is well-behaved where it is near zero, and not highly oscillatory. The mean and variance (and standard deviation) of the residuals are proxies for accuracy. When both the variance and the mean approach zero they are indications that the residuals are stationary, which occurs when the ML model produces estimates that closely track actual values. One example of this second range and corresponding boost function is shown and described below with reference to blocks 340 and 345 of FIG. 3.
3) In a third range (the memory-specific range), where the number of training observations becomes somewhat large and the quadratic growth based on the number of sensors begins to bite into both the memory footprint and compute cost, the inferential exemplar selection technique tapers the boost function with an empirically derived square root taper coefficient. One example of this third range and corresponding boost function is shown and described below with reference to blocks 350 and 355 of FIG. 3.
4) In a fourth range (the processor-specific range), where the number of training observations become very large, even though the memory cost would stay reasonable with application of the square root taper coefficient in the boost function, the cubic term now dominates the overall compute cost, and so the inferential exemplar selection technique tapers the boost function with an empirically derived cube root taper coefficient. One example of this fourth range and corresponding boost function is shown and described below with reference to blocks 360 and 365 of FIG. 3.

In one embodiment, these criteria enable inferential vector selection that autonomously selects an optimal number of exemplar vectors for use in training the ML model. As used here, a number of exemplar vectors being “optimal” indicates that the number of exemplar vectors is near or at an amount where further returns on accuracy from adding more exemplar vectors has diminished to a point that the increased compute resource consumption due to adding more exemplar vectors has become exorbitant. An optimal number of exemplar vectors is thus a “just right” amount to strike a balance between ML model accuracy and resource consumption for training and operation.

The standard deviation of residuals produced by an ML model trained with a given quantity of exemplar vectors monotonically decreases as the given quantity of exemplar vectors increases. The mean (bias) of the residuals produced by the ML model trained with the given quantity of exemplar vectors asymptotically approaches zero as the given quantity of exemplar vectors increases. The standard deviation and mean of residuals are proxies for accuracy, as discussed above. There is thus an asymptotic increase in ML model accuracy as the quantity of exemplars used to train the ML model increases. So, there is a limit or point of diminishing returns on increasing accuracy by training with larger quantities of exemplar vectors.

Accuracy may also be specified as false alarm probabilities (FAPs) and missed alarm probabilities (MAPs). In one embodiment, the inferential exemplar selection techniques, systems, and methods described herein select quantities of exemplars that keep FAPs and MAPs of ML models trained on the exemplars within acceptable levels, for example, both FAPs and MAPs below 0.01. In one embodiment, the inferential exemplar selection techniques, systems, and methods described herein get acceptable prognostic performance (that is, accuracy) without causing the compute cost to be so high as to be unable to keep up, or causing a crash due to exhausting memory. In one embodiment, the inferential exemplar selection techniques, systems, and methods described herein select approximately a minimum number of exemplar vectors to reach the acceptable prognostic performance, and so do not cause unnecessary consumption of compute resources.

In one embodiment, the use of the term “inferential” herein to refer to exemplar selection refers to inferring a quantity of exemplar vectors that strikes an acceptable balance between accuracy and compute cost from the relationships between number of exemplar vectors used for training the ML model and the resulting compute cost for the ML model. The inferential exemplar selection techniques, systems, and methods described herein infer a satisfactory quantity of exemplar vectors from the cubic relationship between exemplar quantity and compute cost, and the asymptotic relationship between exemplar quantity and accuracy. In one embodiment, the inferential exemplar selection techniques, systems, and methods described herein infers a quantity of exemplar vectors that give the expected accuracy, but significantly reduces compute cost to achieve the accuracy.

In one embodiment, training an ML model with the quantity of exemplar vectors indicated by the above criteria ensures reasonable behavior for the prognostic performance (with low false alarm probabilities (FAPs) and low missed alarm probabilities (MAPs)). Also, training the ML model with the quantity of exemplar vectors indicated by the above criteria avoids causing memory requirements to increase (quadratically) without bound, and prevents compute cost from growing (cubically) in an uncontrolled manner. In one embodiment, these improvements provided by the inferential exemplar selection techniques, systems, and methods described herein are applicable on any computing device, and thus improve the performance of the computing device without brute force application of computing power.

### —Additional Example Inferential Exemplar Selection Method—

FIG. 3 illustrates one embodiment of an example inferential exemplar selection method 300 showing selection between four boost functions based on available quantity of training vectors. In one embodiment, inferential exemplar selection method 300 initiates at START block 305 in response to conditions similar to those that initiate inferential exemplar selection method 200 as described above, and proceeds to process block 310.

At process block 310, inferential exemplar selection method 300 initializes a signal database that includes a quantity M of time series signals. The M time series signals may be supplied as inputs to the machine learning model. At process block 315, inferential exemplar selection method 300 determines a number of training observations N. The number of training observations N is the available quantity of training vectors that are available in the signal database. In one embodiment, the number of training observations N is pre-established. For example, the number of training observations N is a time range of the signal database, such as the first half of the observations in the signal database.

At process block 320, the training observations (training vectors) are partitioned into ten windows (Windows=10). Other numbers of windows may also be used. It is possible that the training observations may include readings of activity that varies from one end of the data. This can result in an inequitable distribution of exemplar vectors when the exemplar vectors are selected across the entire set of training observations. To prevent this, the training observations may be partitioned into multiple windows, and an equal (or approximately equal) number of exemplars sampled from within each window.

One of four boost functions 325 for determining the number of memory vectors NmV (also referred to herein as the selection quantity of exemplar vectors) is then chosen or selected based on the number of training observations N. The quantity ranges and values of thresholds between quantity ranges specified herein are examples specific to one embodiment implemented with a particular underlying hardware configuration. Accordingly, other quantity ranges or values for thresholds between the quantity ranges may also be used. The systems and methods presented herein are not limited to the ranges or examples described herein. Rather, the ranges are flexible and can be adapted to other hardware configurations consistently with the principles and features disclosed herein for selection of a boost function. In one embodiment, the quantity ranges are discrete and do not overlap. References herein to “approximate” values when describing the boundaries between the quantity ranges indicate that the value separating one range from another may vary, for example, by as much as 10 percent from the stated value.

At decision block 330, the number of training observations N is evaluated to determine whether the number of training observations N falls within a first quantity range associated with a first boost function. In one embodiment, the first quantity range is values of N below a small available quantity of training vectors, on the order of tens or hundreds of available training vectors. For example, a number of training observations N (or available quantity of training vectors) below approximately 100 is so small as not to cause memory or processor time to be significant during training of an ML model with the training observations. Where the number of training observations Nis less than or equal to 100 (or other range of small available quantities of training vectors) (330: YES), the number of training observations N is within the first quantity range, and inferential exemplar selection method 300 chooses the first boost function and proceeds to process block 335. Where the number of training observations N is greater than 100 (330: NO), the number of training observations N is not within the first quantity range. Inferential exemplar selection method 300 does not select the first boost function and instead proceeds to decision block 340.

At decision block 340, the number of training observations N is evaluated to determine whether the number of training observations N falls within a second quantity range associated with a second boost function. In one embodiment, the second quantity range is values of N that are a moderate available quantity of training vectors, such as between tens of available training vectors and thousands of training vectors. For example, a number of training observations N (or available quantity of training vectors) above approximately 100 and below approximately 2,000 remains small enough that memory or processor time are insignificant during ML model training, but has become large enough that exemplar vectors can be sampled from multiple windows to avoid introducing variance or bias into the ML model. Where the number of training observations N is greater than 100 and less than or equal to 2,000 (or other range of moderate available quantities of training vectors) (340: YES), the number of training observations N is within the second quantity range, and inferential exemplar selection method 300 chooses the second boost function and proceeds to process block 345. Where the number of training observations N is greater than 2000 (340: NO), the number of training observations Nis not within the second quantity range. Inferential exemplar selection method 300 does not select the second boost function and instead proceeds to decision block 350.

At decision block 350, the number of training observations N is evaluated to determine whether the number of training observations N falls within a third quantity range (a memory-specific range) associated with a third boost function. In one embodiment, the third quantity range is values of N that are a large available quantity of training vectors, such as between hundreds of available training vectors and tens of thousands of training vectors. For example, a number of training observations N (or available quantity of training vectors) above approximately 2,000 and below approximately 10,000 is a quantity range where memory becomes a dominant factor during ML model training. Where the number of training observations N is greater than 2,000 and less than or equal to 10,000 (or other range of large available quantities of training vectors) (350: YES), the number of training observations Nis within the third quantity range, and inferential exemplar selection method 300 chooses the third boost function and proceeds to process block 355. Where the number of training observations N is greater than 10,000 (345: NO), the number of training observations N is not within the third quantity range. Inferential exemplar selection method 300 does not select the third boost function and instead proceeds to process block 360.

At process block 360, the number of training observations N has been determined to be within a fourth quantity range (a processor-specific range) associated with a fourth boost function. In one embodiment, the fourth quantity range is values of N that are a very large available quantity of training vectors, such as more than several thousand training vectors. For example, a number of training observations N (or available quantity of training vectors) above approximately 10,000 is a quantity range where processing cost becomes a dominant factor during ML model training. Where the number of training observations N is greater than 10,000 (or other range of very large available quantities of training vectors), the number of training observations Nis within the fourth quantity range, and inferential exemplar selection method 300 chooses the fourth boost function and proceeds to process block 365.

In one embodiment, the compute resources are discrete units with pre-set configurations of memory and processing capacity, such as containers, virtual machines, or bare metal computer hardware. Accordingly, expansion of compute resources adds memory and processing capacity in correlated amounts defined by the configuration or shape of the compute resource. Thus, in one embodiment, increases in memory increase processing capacity, and increases in processing capacity increase memory. In one embodiment, memory being the “dominant” factor or constraint during training indicates that increases in memory footprint drive expansion of compute resources, with processor cost (that is, processor time) being satisfied by resources assigned to accommodate the memory footprint. In one embodiment, processing cost being the “dominant” factor or constraint during training indicates that increases in processor runtime drive expansion of compute resources, with memory footprint being satisfied by resources assigned to accommodate the processing cost.

At process block 335, inferential exemplar selection method 300 calculates the number of memory vectors NmV (the selection quantity of exemplar vectors) using the first boost function. In one embodiment, the first boost function is given by Eq. 1 below:

$$NmV = 2 * M \qquad Eq . 1$$

At process block 345, inferential exemplar selection method 300 calculates the number of memory vectors NmV (the selection quantity of exemplar vectors) using the second boost function. In one embodiment, the second boost function is given by Eq. 2 below:

$$NmV = 2 * M * Windows \qquad Eq . 2$$

In one embodiment, where the equations include Windows, the selection or sampling of exemplar vectors (at process block 380) will be apportioned among the windows. For example, a selection of exemplar vectors for Eq. 2 above selects 2*M vectors per window.

At process block 355, inferential exemplar selection method 300 calculates the number of memory vectors NmV (the selection quantity of exemplar vectors) using the third boost function. In one embodiment, the third boost function is given by Eq. 3 below:

$$NmV = 2 * M * Windows * \sqrt{\frac{N}{1600}} \qquad Eq . 3$$

In Eq. 3, a square root tapering coefficient is given by the square root of the number of training observations N divided by 1600. Values other than 1600 may also be appropriate, for example values in a range from 1200 to 2400.

At process block 365, inferential exemplar selection method 300 calculates the number of memory vectors NmV (the selection quantity of exemplar vectors) using the fourth boost function. In one embodiment, the fourth boost function is given by Eq. 4 below:

$$NmV = 2 * M * Windows * \sqrt[3]{N} * 0.15 \qquad Eq . 4$$

In Eq. 4, a cube root tapering coefficient is given by 0.15 multiplied by the cube root of the number of training observations N. Values other than 0.15 may also be appropriate, for example values in a range between 0.05 and 0.50. After the number of memory vectors NmV (the selection quantity of exemplar vectors) is generated using one of the four boost functions 325, inferential exemplar selection method 300 proceeds to decision block 370.

At decision block 370, inferential exemplar selection method 300 determines whether the number of memory vectors NmV (the selection quantity of exemplar vectors) is more than the number of training observations N (the available quantity of training vectors). In one embodiment, the number of training observations N is fixed, and further observations will not be added to the training observations in order to satisfy a larger number of memory vectors. Instead, where the number of memory vectors NmV (the selection quantity of exemplar vectors) is more than the number of training observations N (370: YES), the number of memory vectors NmV (the selection quantity of exemplar vectors) will be reduced to the number of training observations Nat process block 375. This constrains the number of memory vectors NmV (the selection quantity of exemplar vectors) to be within the available training observations (the available quantity of training vectors). Where the number of memory vectors NmV (the selection quantity of exemplar vectors) is more than the number of training observations N (370: NO), the memory vectors (exemplar vectors) can be satisfied from the available training observations, and no reduction is performed. Following reduction of the number of memory vectors at process block 375 or a determination at process block 370 that no such reduction will be performed, inferential exemplar selection method 300 proceeds to process block 380.

At process block 380, inferential exemplar selection method 300 selects the selection quantity NmV of memory vectors (exemplar vectors) from the training portion of the signal database. In one embodiment, the training portion of the signal database is made up of the N training observations (training vectors). At process block 385, inferential exemplar selection method 300 trains an ML model using the selected memory vectors. In one example, the ML model is a multivariate state estimation technique (MSET) model. At process block 390, inferential exemplar selection method 300 monitors time series signals with the trained machine learning model. The time series signals are monitored to detect anomalous values of the signals. The monitoring or surveillance may be performed on the remainder of the signal database, or on incoming live data. Following process block 390, inferential exemplar selection method 300 concludes at END block 395.

### —Overview of Multivariate ML Anomaly Detection—

In general, multivariate ML modeling techniques used for ML anomaly detection predict or estimate what each signal should be or is expected to be based on the other signals in a database or collection of time series signals. The predicted signal may be referred to as the “estimate”. A multivariate ML anomaly detection model is used to make the predictions or estimates for individual variables based on the values provided for other variables. For example, for Signal 1 in a database of N signals, the multivariate ML anomaly detection model will generate an estimate for Signal 1 using signals 2 through N.

In one embodiment, the ML anomaly detection model may be a non-linear non-parametric (NLNP) regression algorithm used for multivariate anomaly detection. Such NLNP regression algorithms include auto-associative kernel regression (AAKR), and similarity-based modeling (SBM) such as the multivariate state estimation technique (MSET) (including Oracle's proprietary Multivariate State Estimation Technique (MSET2)). In one embodiment, the ML anomaly detection model may be another form of algorithm used for multivariate anomaly detection, such as a neural network (NN), Support Vector Machine (SVM), or Linear Regression (LR).

The ML anomaly detection model is trained to produce estimates of what the values of variables should be based on training with exemplar vectors that are designated to represent expected, normal, or correct operation of a monitored asset. To train the ML anomaly detection model, the exemplar vectors are used to adjust the ML anomaly detection model. A configuration of correlation patterns between the variables of the ML anomaly detection model is automatically adjusted based on values for variables in the exemplar vectors. The adjustment process continues until the ML anomaly detection model produces accurate estimates for each variable based on inputs to other variables. Sufficient accuracy of estimates to conclude determine the ML anomaly detection model to be sufficiently trained may be determined by residuals-a residual is a difference between an actual value (such as a measured, observed, sampled, or resampled value) and an estimate, reference, or prediction of what the value is expected to be—being minimized below a pre-configured training threshold. At the completion of training, the ML anomaly detection model has learned correlation patterns between variables.

Following training, the ML anomaly detection model may be used to monitor time series signals. Subtracting an actual, measured value for each signal from a corresponding estimate gives the residuals or differences between the values of the signal and estimate. Where there is an anomaly in a signal, the measured signal value departs from the estimated signal value. This causes the residuals to increase, triggering an anomaly alarm. Thus, the residuals are used to detect such anomalies where one or more of the residuals indicates such a departure, for example by becoming consistently excessively large.

For example, the presence of an anomaly may be detected by a sequential probability ratio test (SPRT) analysis of the residuals, as discussed in detail above. In one embodiment, the SPRT calculates a cumulative sum of the log-likelihood ratio for each successive residual between an actual value for a signal and an estimated value for the signal, and compares the cumulative sum against a threshold value indicating anomalous deviation. Where the threshold is crossed, an anomaly is detected, and an alert indicating the anomaly may be generated.

### —Electronic Alerts—

In one embodiment, an electronic alert is generated by composing and transmitting a computer-readable message. The computer readable message may include content describing the anomaly that triggered the alert, such as a time or time stamp for when the anomaly was detected, an indication of the signal value that caused the anomaly, an identification of a source of the signal (such as an asset or component) for which the anomaly occurred and the alert is applicable. In one embodiment, an electronic alert may be generated and sent in response to a detection of an anomalous signal value. The electronic alert may be composed and then transmitted for subsequent presentation on a display or other action.

In one embodiment, the electronic alert is a message that is configured to be transmitted over a network, such as a wired network, a cellular telephone network, wi-fi network, or other communications infrastructure. The electronic alert may be configured to be read by a computing device. The electronic alert may be configured as a request (such as a REST request) used to trigger initiation of a function in response to detection of an anomaly, such as triggering a maintenance response for an asset monitored by the anomalous signal. In one embodiment, the electronic alert may be presented in a user interface such as a graphical user interface (GUI) by extracting the content of the electronic alert by a REST API that has received the electronic alert. The GUI may present a message, notice, or other indication that the monitored asset has entered (or left) an anomalous state of operation.

### —Cloud or Enterprise Embodiments—

In one embodiment, the present system (such as inferential exemplar selection system 100) is a computing/data processing system including a computing application or collection of distributed computing applications for access and use by other client computing devices that communicate with the present system over a network. In one embodiment, inferential exemplar selection system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, inferential exemplar selection system 100 is a centralized server-side application that provides at least the functions disclosed herein and that is accessed by many users by way of computing devices/terminals communicating with the computers of inferential exemplar selection system 100 (functioning as one or more servers) over a computer network. In one embodiment inferential exemplar selection system 100 may be implemented by a server or other computing device configured with hardware and software to implement the functions and features described herein.

In one embodiment, the components of inferential exemplar selection system 100 may be implemented as sets of one or more software modules executed by one or more computing devices specially configured for such execution. In one embodiment, the components of inferential exemplar selection system 100 are implemented on one or more hardware computing devices or hosts interconnected by a data network. For example, the components of inferential exemplar selection system 100 may be executed by network-connected computing devices of one or more computer hardware shapes, such as central processing unit (CPU) or general-purpose shapes, dense input/output (I/O) shapes, graphics processing unit (GPU) shapes, and high-performance computing (HPC) shapes.

In one embodiment, the components of inferential exemplar selection system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of inferential exemplar selection system 100 may (i) generate or compose an electronic message or signal to issue a command or request to another component, (ii) transmit the message or signal to other components of inferential exemplar selection system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by inferential exemplar selection system 100, for example through a web interface server. In one embodiment, the remote computing system may send requests to and receive responses from inferential exemplar selection system 100. In one example, access to the information or applications may be effected through use of a web browser on a personal computer or mobile device. In one example, communications exchanged with inferential exemplar selection system 100 may take the form of remote representational state transfer (REST) requests using JavaScript object notation (JSON) as the data interchange format for example, or simple object access protocol (SOAP) requests to and from XML servers. The REST or SOAP requests may include API calls to components of inferential exemplar selection system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

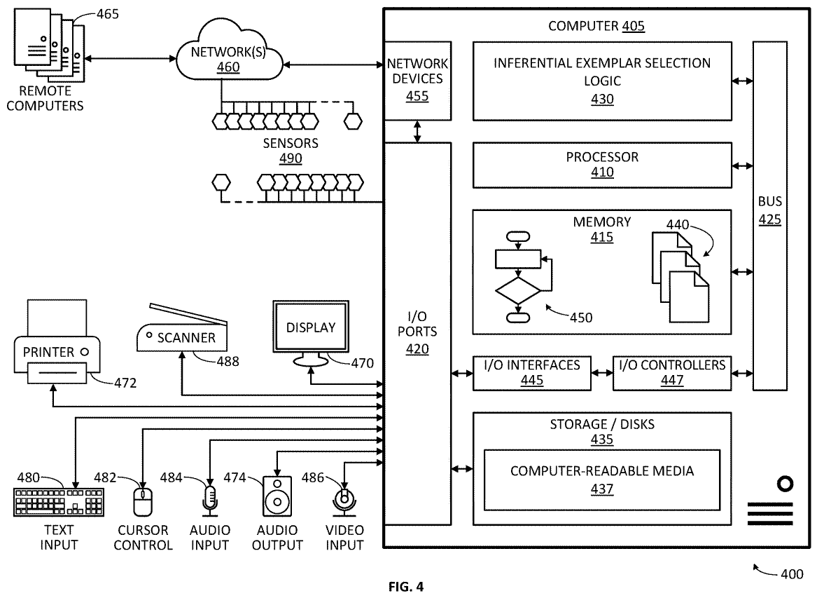

FIG. 4 illustrates an example computing system 400 that is configured and/or programmed as a special purpose computing device(s) with one or more of the example systems and methods described herein, and/or equivalents. The example computing system 400 may include a computer 405 that includes at least one hardware processor 410, a memory 415, and input/output ports 420 operably connected by a bus 425. In one example, the computer 405 may include inferential exemplar selection logic 430 configured to facilitate selecting a sufficient quantity of exemplar vectors for accurate ML training without causing training to exceed resource constraints, similar to logic, systems, methods, and other embodiments shown in and described with reference to FIGS. 1, 2, and 3.

In different examples, the logic 430 may be implemented in hardware, a non-transitory computer-readable medium 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate selecting a sufficient quantity of exemplar vectors for accurate ML training without causing training to exceed resource constraints. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, ROM, PROM, and so on. Volatile memory may include, for example, RAM, SRAM, DRAM, and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state disk drive, a floppy disk drive, a tape drive, a Zip drive, a flash memory card, a memory stick, and so on. Furthermore, the disk 435 may be a CD-ROM drive, a CD-R drive, a CD-RW drive, a DVD ROM, and so on. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, network devices 455, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network, the computer 405 may be logically connected to remote computers 465. Networks with which the computer 405 may interact include, but are not limited to, a LAN, a WAN, and other networks.

In one embodiment, the computer may be connected to sensors 490 through I/O ports 420 or networks 460 in order to receive information about physical states of monitored machines, devices, systems, or facilities (collectively referred to as “assets”). In one embodiment, sensors 490 are configured to monitor physical phenomena occurring in or around an asset. The assets generally include any type of machinery or facility with components that perform measurable activities. In one embodiment, sensors 490 may be operably connected or affixed to assets or otherwise configured to detect and monitor physical phenomena occurring in or around the asset. The sensors 490 may be network-connected sensors for monitoring any type of physical phenomena. The network connection of the sensors 490 and networks 460 may be wired or wireless.

In one embodiment, computer 405 is configured with logic, such as software modules, to collect readings from sensors 490 and store them as observations in a time series data structure such as a time series vector, time series signal, or time series database. In one embodiment, the computer 405 polls sensors 490 to retrieve sensor telemetry readings. In one embodiment, the sensor telemetry readings may be a time series of vectors with sensed values for each of sensors 490. In one embodiment, the computer 405 passively receives sensor telemetry readings actively transmitted by sensors 490. In one embodiment, the computer 405 receives one or more collections, sets, or databases of sensor telemetry readings previously collected from sensors 490, for example from storage 435 or from remote computers 465.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

A “plurality”, as used herein, refers to more than one of something, or the fact or state of being plural.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
determining an available quantity of training vectors that are available in a set of time series signals, wherein the training vectors are designated for use in training a machine learning model;
automatically selecting a boost function from a plurality of different boost functions, wherein the selected boost function is selected based on the available quantity of the training vectors falling within a quantity range associated with the selected boost function, and wherein each boost function from the plurality of different boost functions is configured to determine a different selection quantity of exemplar vectors to be selected from the training vectors;
generating a selection quantity of the exemplar vectors to select from the training vectors by applying the selected boost function to the training vectors;
selecting a quantity of the exemplar vectors from the training vectors based on the selection quantity; and
training the machine learning model to detect anomalies in the time series signals based on the exemplar vectors that were selected.

2. The computer-implemented method of claim 1, wherein the selected boost function adjusts the selection quantity of the exemplar vectors by a different coefficient for each of a set of quantity ranges, wherein the set of quantity ranges includes the quantity range.

3. The computer-implemented method of claim 1, further comprising applying a taper coefficient in the boost function, wherein the taper coefficient reduces the selection quantity by an extent that is based on the available quantity of the training vectors.

4. The computer-implemented method of claim 1, further comprising, in response to the quantity range satisfying a threshold for being a memory-specific range, applying a square root taper coefficient in the boost function, wherein the square root taper coefficient is a square root function of the available quantity of the training vectors.

5. The computer-implemented method of claim 1, further comprising, in response to the quantity range satisfying a threshold for being a processor-specific range, applying a cube root taper coefficient in the boost function, wherein the cube root taper coefficient is a cube root function of the available quantity of the training vectors.

6. The computer-implemented method of claim 1, wherein automatically selecting a boost function further comprises:
where the quantity range is less than a first threshold, selecting a first boost function that is a linear function of a signal quantity of the time series signals;
where the quantity range is between the first threshold and a second threshold that is higher than the first threshold, selecting a second boost function that is a function of a window quantity of windows that subdivide the training vectors and the signal quantity of the time series signals;
where the quantity range is between the second threshold and a third threshold that is higher than the second threshold, selecting a third boost function that is tapered by a square root function of the available quantity of the training vectors; and
where the quantity range is more than the third threshold, selecting a fourth boost function that is tapered by a cube root function of the available quantity of the training vectors.

7. The computer-implemented method of claim 1, further comprising subdividing the training vectors into a predetermined number of windows, wherein the quantity of the exemplar vectors are selected from the training vectors within more than one of the windows.

8. The computer-implemented method of claim 1, wherein the method further comprises, prior to selecting the exemplar vectors from the training vectors, constraining the selection quantity of the exemplar vectors to not exceed the available quantity of the training vectors.

9. The computer-implemented method of claim 1, further comprising:
monitoring the time series signals with the trained machine learning model to detect an anomaly; and
in response to detecting a particular anomaly in the time series signals, generating an electronic alert that the particular anomaly has occurred.

10. A non-transitory computer-readable medium that includes stored thereon computer-executable instructions that when executed by at least a processor of a computer system cause the computer system to:
determine an available quantity of training vectors that are available in a set of time series signals, wherein the training vectors are designated for use in training a machine learning model;
automatically select a boost function from a plurality of different boost functions, wherein the selected boost function is selected based on the available quantity of the training vectors falling within a quantity range, and wherein each boost function from the plurality of different boost functions is configured to determine a different selection quantity of exemplar vectors to be selected from the training vectors;
generate a selection quantity of exemplar vectors to select from the training vectors by performing the selected boost function;
select a quantity of the exemplar vectors from the training vectors based on the selection quantity; and
train the machine learning model to detect an anomaly in the time series signals based on the selected exemplar vectors.

11. The non-transitory computer-readable medium of claim 10, wherein the selected boost function further comprises instructions that when executed by at least the processor cause the computer system to adjust the selection quantity of the exemplar vectors by a differing coefficient for each of a set of quantity ranges, wherein the set of quantity ranges includes the quantity range.

12. The non-transitory computer-readable medium of claim 10, further comprising instructions that when executed by at least the processor cause the computer system to apply a square root taper coefficient in the boost function, wherein the square root taper coefficient attenuates the selection quantity by a square root function of the available quantity of the training vectors.

13. The non-transitory computer-readable medium of claim 10, further comprising instructions that when executed by at least the processor cause the computer system to apply a cube root taper coefficient in the boost function, wherein the cube root taper coefficient attenuates the selection quantity by a cube root function of the available quantity of the training vectors.

14. The non-transitory computer-readable medium of claim 10, wherein the instructions for automatically selecting the boost function when executed by at least the processor further cause the computer system to:
in response to the available quantity falling within a quantity range for which neither memory nor processor time are significant constraints of the resource constraints, selecting a first boost function that is a linear function of a signal quantity of the time series signals;
in response to the available quantity falling within a quantity range for which the available quantity is sufficiently large to allow short term activity to be missed, selecting a second boost function that is a function of a window quantity of windows that subdivide the training vectors and the signal quantity of the time series signals;
in response to the available quantity falling within a quantity range for which memory footprint drives resource consumption, selecting a third boost function that is tapered by a square root function of the available quantity of the training vectors; and
in response to the available quantity falling within a quantity range for which processor time drives resource consumption, selecting a fourth boost function that is tapered by a cube root function of the available quantity of the training vectors.

15. A computing system, comprising:
at least one processor;
at least one memory connected to the at least one processor;
a non-transitory computer readable medium including instructions stored thereon that when executed by at least the processor cause the computing system to:
determine an available quantity of training vectors that are available in a set of time series signals, wherein the training vectors are designated for use in training a machine learning model;
in response to the available quantity of the training vectors being within a first quantity range, select a first boost function from a plurality of different boost functions, and in response to the available quantity of the training vectors being within a second quantity range, select a second boost function from the plurality of different boost functions, wherein each boost function of the plurality of different boost functions is configured to determine a different selection quantity of exemplar vectors to be selected from the training vectors;
generate a selection quantity of exemplar vectors to select from the training vectors;
select a quantity of the exemplar vectors from the training vectors based on the selection quantity; and
train the machine learning model to detect anomalies in the time series signals based on the exemplar vectors that were selected.

16. The computing system of claim 15, wherein the instructions to generate the selection quantity of exemplar vectors further cause the computing system to:
in response to selection of the first boost function, adjust the selection quantity of the exemplar vectors by a first coefficient, and
in response to selection of the second boost function, adjust the selection quantity of the exemplar vectors by a second coefficient.

17. The computing system of claim 15, wherein the instructions to generate the selection quantity of exemplar vectors further cause the computing system to:
in response to selection of the first boost function, lessen the selection quantity of the exemplar vectors by a square root taper coefficient that attenuates the selection quantity by a square root function, and
in response to selection of the second boost function, lessen the selection quantity of the exemplar vectors by a cube root taper coefficient that attenuates the selection quantity by a cube root function.

18. The computing system of claim 15, wherein the instructions further cause the computing system to:
subdivide the training vectors into a plurality of windows; and
increase the selection quantity of the exemplar vectors to accommodate selections of the training vectors from within the plurality of windows.

19. The computing system of claim 15, wherein the instructions further cause the computing system to reduce the selection quantity of the exemplar vectors to the available quantity of the training vectors in response to the selection quantity exceeding the available quantity.

20. The computing system of claim 15, wherein the instructions further cause the computing system to detect an anomaly in the time series signals using the trained machine learning model.
